(19) United States
(12) Patent Application Publication
(10) Pub. No.: US 2019/0003230 A1
(43) Pub. Date: Jan. 3, 2019

(54) DEVICE FOR OPENING AND CLOSING AN OUTWARDLY OPENING PIVOTING WING

(71) Applicant: SAVIO S.p.A., Chiusa San Michele (Torino) (IT)

(72) Inventor: Aimone BALBO DI VINADIO, Chiusa San Michele (Torino) (IT)

(73) Assignee: SAVIO S.p.A., Chiusa San Michele (Torino) (IT)

(21) Appl. No.: 15/747,720

(22) PCT Filed: Jul. 22, 2016
(86) PCT No.: PCT/IB2016/054377

§ 371 Date: Jan. 25, 2018

(30) Foreign Application Priority Data
Jul. 28, 2015 (IT) 102015000038914

(51) Int. Cl. E05F 11/14; E05F 11/34

(52) U.S. Cl. CPC E05F 11/145; E05Y 2900/148; E05F 11/34

(57) ABSTRACT

A device for opening and closing an outwardly opening pivoting wing includes an actuating device including a base and a toothed member rotatable with respect to the support and driven into rotation by a control device, and an arm having a toothed portion including a circular toothed portion and a straight toothed portion, wherein the toothed member cooperates with the circular toothed section to swing the arm between a closed wing angular position and an open wing angular position, and vice versa, and wherein, in the closed wing angular position, the toothed member cooperates with the straight toothed portion of the arm for moving the arm along a straight direction between a locked wing position and an unlocked wing position, and vice versa, wherein the support and the arm cooperate with each other by means of a guide system comprising a first, a second and a third pin-slot coupling.

### TEXT OF THE DESCRIPTION

### Field of the Invention

The present invention relates to accessories for doors and windows and regards a device for opening and closing an outwardly opening pivoting wing.

The invention can be applied to wings articulated about vertical axes or to wings articulated about horizontal axes.

### Description of the Prior Art

Devices are known for opening and closing an outwardly opening pivoting wing comprising:
an actuating device including a crank associated with a worm screw and a rotatable gear, driven into rotation by said worm screw, and
an arm, oscillating about a fixed pin and having a toothed portion that meshes with said gear, wherein said gear cooperates with the toothed portion to swing the arm between a closed wing angular position and an open wing angular position.

The openable wings are normally equipped with a locking device to lock the wing in the closed position. In the known solutions, the locking/unlocking device of the wing is separate and independent from the opening/closing device of the wing. The locking device can, for example, be controlled by a cremone handle or by any other known type of device. Therefore, two independent maneuvers for controlling the locking/unlocking of the wing and the opening/closing movement are necessary.

U.S. Pat. No. 2,114,645 discloses a device for opening and closing a pivoting wing equipped with a crank-operated device that also controls the locking and unlocking of the wing. The device disclosed in U.S. Pat. No. 2,114,645 comprises:
an actuating device including a support, a crank rotatable with respect to the support and a control mechanism actuated by the crank, and
an arm having a toothed portion, which cooperates with said control mechanism, wherein the control mechanism cooperates with the toothed portion of the arm for swinging the arm between a closed wing angular position and an open wing angular position, and wherein in the closed wing angular position, the control mechanism cooperates with the toothed portion of the arm for the translational motion of the arm along a straight direction between a locked wing position and an unlocked wing position, and vice versa.

One of the drawbacks of the solution described in U.S. Pat. No. 2,114,645 is that, during operation, there may be conditions of jamming between the arm and its pivot pin, especially when the arm is in the transition positions from the translational movement to the swinging movement.

### OBJECT AND SUMMARY OF THE INVENTION

The present invention aims to provide a device for opening and closing an outwardly opening pivoting wing equipped with a crank-operated device that also controls the locking and unlocking of the wing, wherein the arm movement is smooth and free of jamming.

According to the present invention, this object is achieved by a device having the characteristics forming the subject of claim 1.

The claims form an integral part of the disclosure provided here in relation to the invention.

### BRIEF DESCRIPTION OF THE DRAWINGS

The present invention will now be described in detail with reference to the attached drawings, given purely by way of non-limiting example, wherein:

FIGS. 1 and 2 are perspective views of a wing provided with an opening and closing device according to the present invention, in a closed position and an open position, respectively.

FIG. 3 is an exploded perspective view illustrating an opening/closing device according to the present invention together with a locking device,

FIG. 4 is an exploded perspective view of the part indicated by the arrow IV in FIG. 3,

FIGS. 5-8 are partially cross-sectioned plan views illustrating the operation of the device according to the invention.

### DETAILED DESCRIPTION

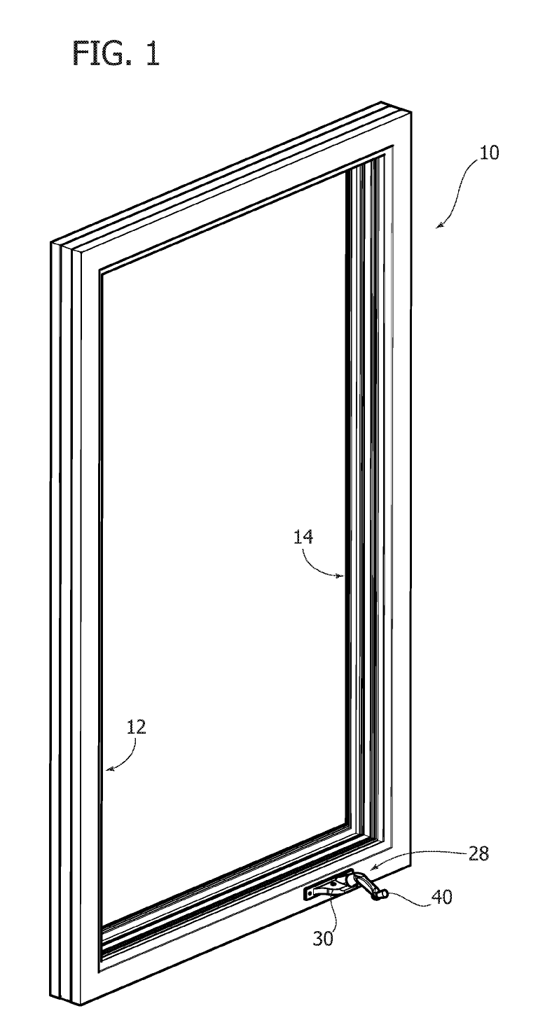

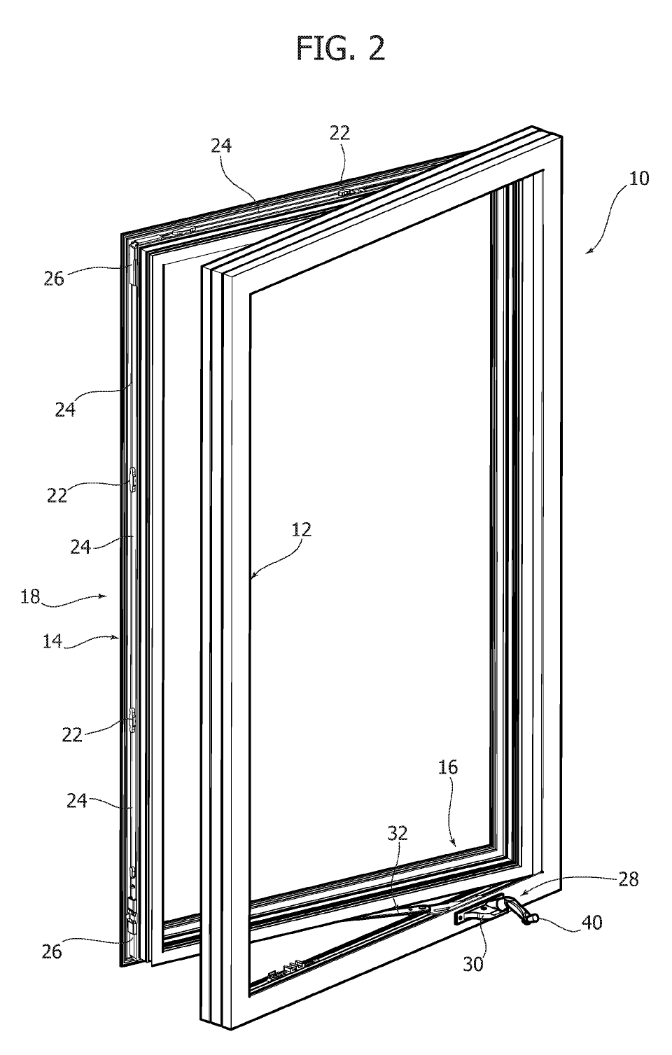

With reference to FIGS. 1 and 2, numeral 10 indicates a window including a fixed frame 12 and a wing 14 articulated to the fixed frame 12 about a vertical axis and outwardly opening.

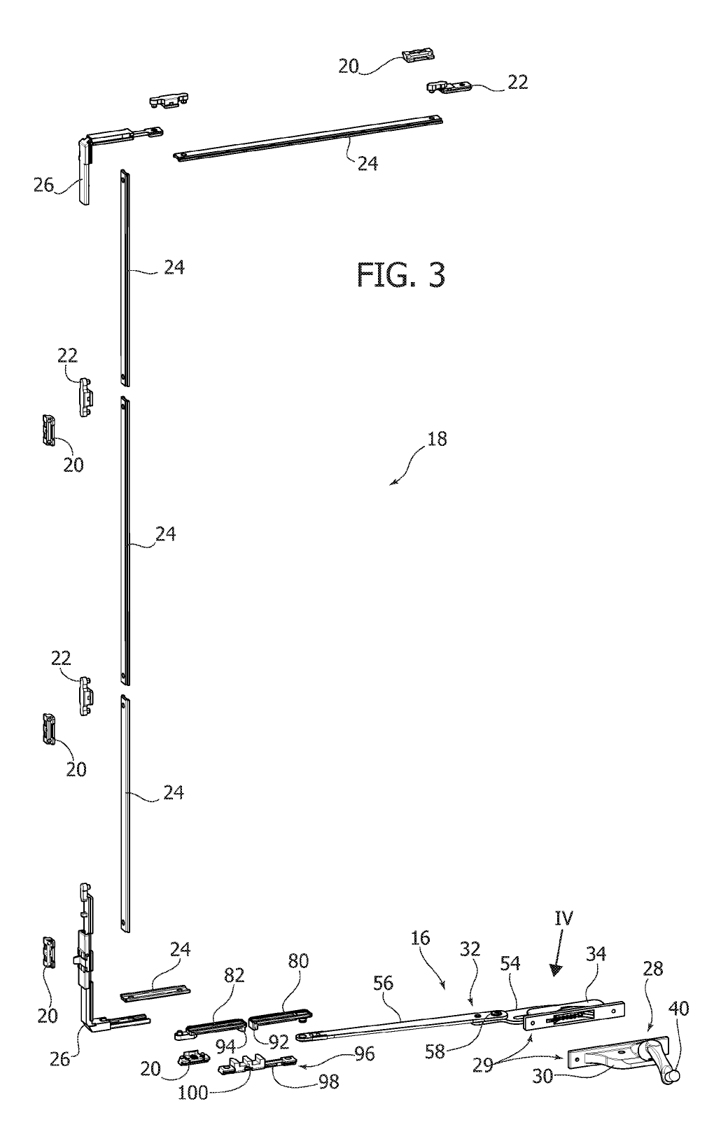

With reference to FIG. 3, numeral 16 indicates a device for opening and closing the pivoting wing 14. The device 16 is intended to be mounted on the fixed frame 12, for example on the lower horizontal side of the frame 12. The wing 14 is provided with a locking device 18 for locking the wing 14 in the closed position. The locking device 18 is of a known type and comprises a plurality of strikers 20 fixed to the frame 12 along the lower horizontal side, the upper horizontal side and along the vertical side opposite to the articulation axis. The locking device 18 comprises a plurality of locking elements 22 cooperating with respective strikers 20. The locking elements are carried by the wing 14 and are located on the lower horizontal side, on the upper horizontal side and on the vertical side of the wing 14 opposite to the articulation axis. The locking elements 22 are movable with respect to the wing 14 between an unlocked position and a locked position. The locking elements 22 are connected together by means of connecting rods 24 and by means of corner drive assemblies 26, in a manner known per se.

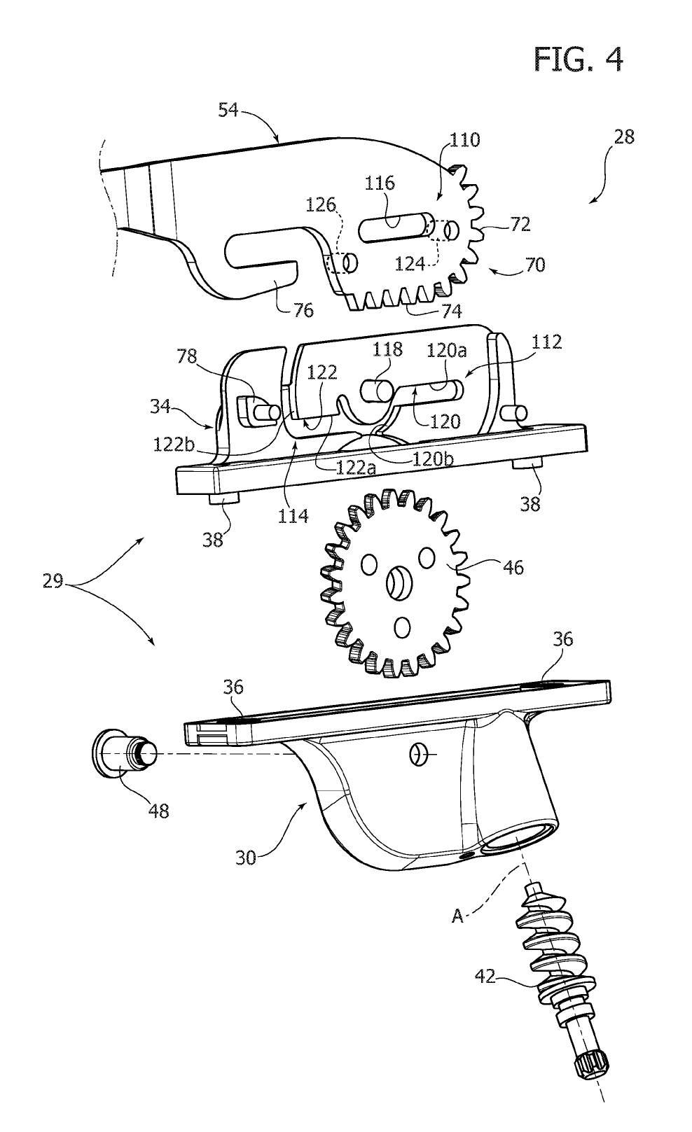

With reference to FIGS. 3 and 4, the opening and closing device 16 comprises a crank-operated device 28 including a base 29 intended to be fixed to the fixed frame 12. In the example illustrated in the figures, the base 29 comprises a first support 30 and a second support 34, intended to be fixed on opposite faces of the same wall of the fixed frame 12. The first and the second supports 30, 34 are provided with respective holes 36, 38 aligned with each other and designed to be engaged by fastening screws (not shown). Alternatively, a single support could be provided that carries out the function of the first and second supports 30, 34.

The first support 30 carries a rotatable crank 40 that is fixed to a worm screw 42 rotatable with respect to the first support 30 about an axis A. The actuating device 28 comprises a toothed member 46 rotatably mounted with respect to the first support 30 about a fixed pin 48 and meshing with the worm screw 42. The crank and the worm screw could be replaced by a control device including an electric motor and a reduction gear that drives the toothed member 46 into rotation.

With reference to FIG. 3, the device 16 comprises an arm 32 carried by the second support 34 in the manner which will be described in more detail below. Preferably, the arm 32 comprises a first arm section 54 and a second arm section 56, fixed together by means of an adjusting device 58 that allows adjustment of the angular position of the second arm portion 56 with respect to the first arm portion 54.

With reference to FIG. 4, the first arm section 54 has a toothed portion 70 that meshes with the toothed member 46. The toothed portion 70 is composed of a circular toothed portion 72 and a straight toothed portion 74. The teeth of the toothed portion 70 extend in a continuous manner and with a constant pitch along the circular toothed portion 72 and along the straight toothed portion 74. The toothed portion 70 can be formed in one piece with the first arm section 54 (as shown in the figures) or can be formed by a separate component fixed to the first arm section 54. The first arm section 54 may be provided with a hook portion 76 configured to engage a striker 78 of the second support 34.

With reference to FIG. 3, the device 16 comprises a first slider 80 and a second slider 82, intended to be slidably mounted within a longitudinal groove of the lower horizontal side of the wing 14. The first slider 80 is articulated to the distal end of the arm 32. The second slider 82 is intended to be connected to a connecting rod 24 of the locking device 18. The sliders 80, 82 are provided with respective projecting teeth 92, 94, which are intended to engage the connecting member 96 that includes a base 98 intended to be fixed to the frame 12 and a movable striker 100 movable on the base 98 in a straight direction. The operation of the sliders 80, 82 and of the connecting member 96 is described in detail in PCT/IB2015/051724. Alternatively, the distal end of the arm 32 may be directly articulated to a rod 24, in turn connected to the corner drive 26.

With reference to FIG. 4, the first arm section 54 and the second support 34 of the base 29 cooperate with each other by means of a guide system comprising a first, a second and a third pin-slot coupling, indicated with 110, 112 and 114, respectively.

The first pin-slot coupling 110 comprises a first straight slot 116 formed in the first arm section 54 and which guides a respective first pin 118 fixed to the second support 34. The first straight slot is parallel to the straight toothed section 74.

The second and the third pin-slot couplings 112, 114 comprise, respectively, a second slot 120 and a third slot 122 formed in the second support 34, which guide, respectively, a second pin 124 and a third pin 126 fixed to the first arm section 54. The second pin 124 and the third pin 126 are arranged on opposite sides with respect to a plane perpendicular to the longitudinal axis of the first slot 116 and passing through the axis of the first pin 118.

The second slot 120 and the third slot 122 each comprise a straight portion 120a, 122a and a circumference arc portion 120b, 122b with the center on the axis of the first pivot pin 118. Preferably, the radii of the two circumference arc portions 120b, 122b are different from each other. In particular, the radius of the circumference arc portion 120b nearest to the circular toothed portion 72 can be less than the radius of the circumference arc portion 122b farthest from the circular toothed portion 72.

Each of the slots 116, 120, 122 has two opposite guide walls spaced apart by a distance equal to the diameter of the respective pin 118, 124, 126, so that the pins 118, 124, 126 are constrained to move along the respective slots 116, 120, 122, without the possibility of moving in other directions.

The position of the slots 116, 120, 122 and of the respective pins 118, 124, 126 could be different from that illustrated in the drawings, what matters is that each slot 116, 120, 122 and the respective pin 118, 124, 126 are on different components between the second support 34 and the first arm section 54.

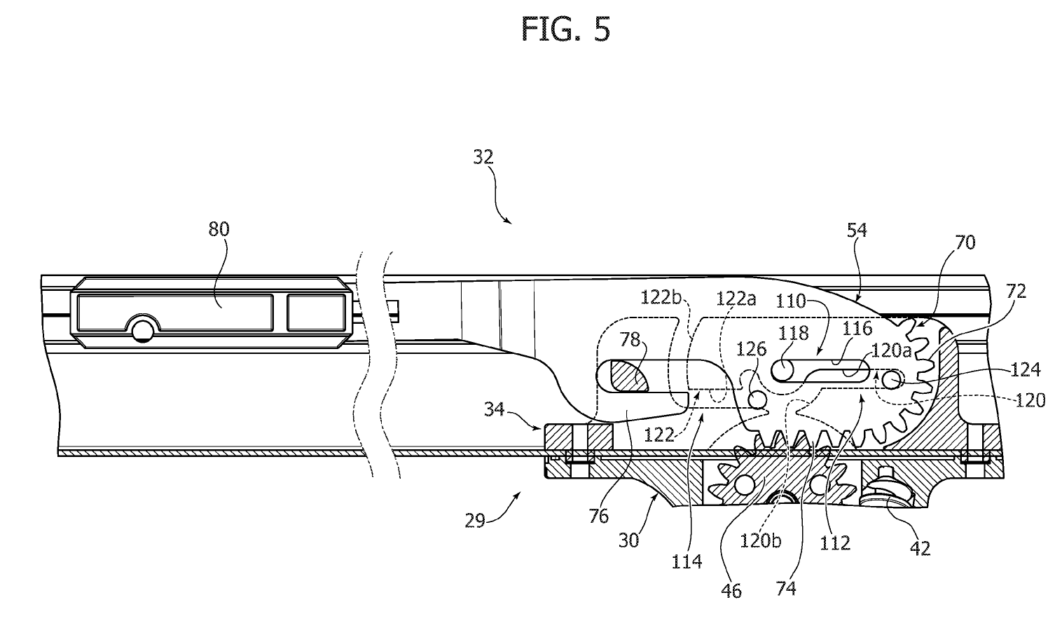

The operation of the opening and closing device 16 will be described below with reference to FIGS. 5-8. In FIG. 5, the arm 32 is in a closed and locked wing position. In this position, the toothed member 46 engages with the straight toothed portion 74 of the teeth 70. The pin 118 is in contact with one end of the slot 116 opposite to the circular toothed portion 72. The pins 124 and 126 engage the straight portions 120a and 122a of the respective slots 120, 122. In this position, the wing 14 is closed and the closing elements 22 of the locking device 18 (FIG. 3) engage respective strikers 20. The hook formation 76 of the first arm section 54 engages the respective striker 78 of the support 34. In this condition, the wing 14 is locked with respect to the frame 12 along the lower horizontal side, the upper horizontal side and along the vertical side opposite to the articulation axis of the wing 14.

Starting from the closed and locked wing position illustrated in FIG. 5, the control device 28 allows unlocking and opening of the wing 14 by means of a single rotation of the handle 40 in the same direction. The rotation of the handle 40 drives the toothed member 46 into rotation by means of the worm screw 42.

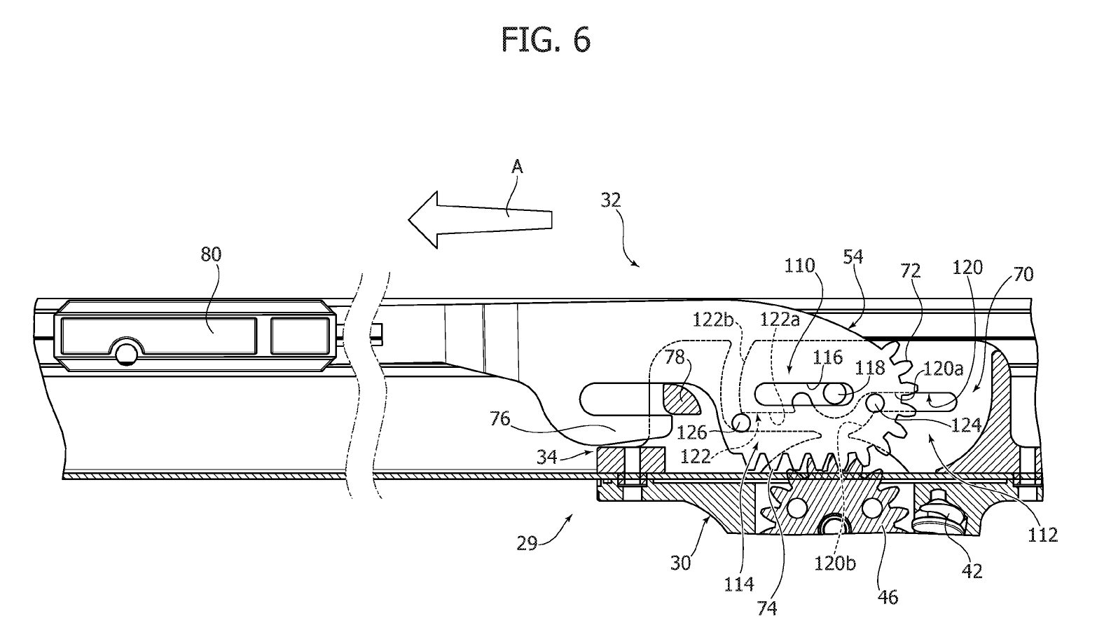

With reference to FIG. 6, in a first step, the toothed member 46 controls the movement in the straight direction of the arm 32 in the direction indicated by the arrow A due to the meshing of the toothed member 46 with the straight toothed portion 74 of the teeth 70. The movement in the straight direction of the arm 32 terminates when the pin 118 comes into abutment against the end of the slot 116 facing the circular toothed portion 72. During the movement in the straight direction A of the arm 32, the pins 124, 126 move along the respective straight portions 120a and 122a of the slots 120, 122. When the pin 118 comes into abutment against the end of the slot 116 facing the circular toothed portion 72, the pins 124, 126 enter into the respective circular portions 120b, 122b of the slots 120, 122.

In this condition, the hook portion 76 is disengaged from the respective striker 78 and all the closing elements 22 of the locking device 18 disengage from the respective fixed strikers 20. In this condition, the wing 14 is still in the closed position but is unlocked. The pin 118 moves relatively to the slot 116 along a straight path with a length equal to the stroke of the arm 32 between the closed and locked wing position and the closed and unlocked wing position.

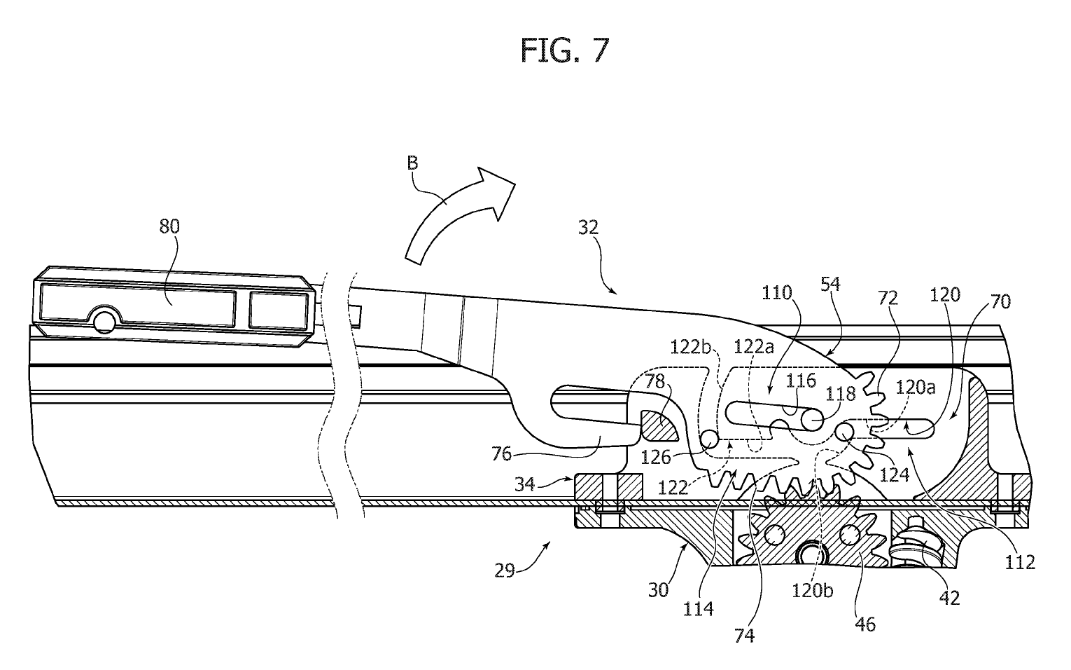

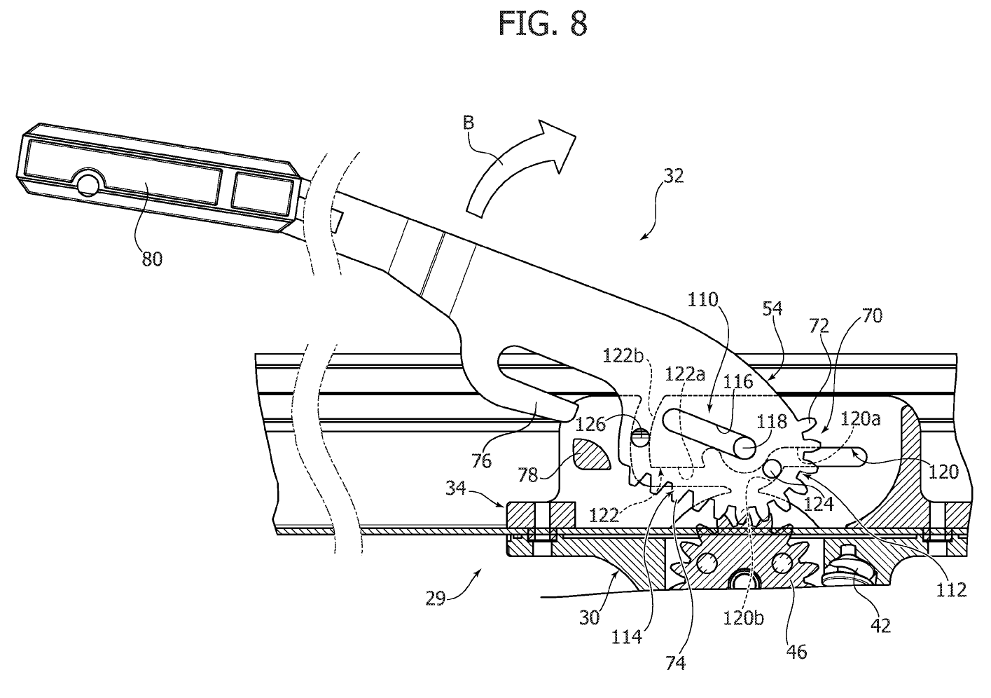

Continuing to rotate the crank 40 in the same direction, the toothed member 46 meshes with the circular toothed portion 72 of the teeth 70 and drives the arm 32 into rotation about the pin 118 in the direction indicated by the arrows B in FIGS. 7 and 8.

The rotation of the arm 32 about the pin 118 opens the wing 14. During the movement of unlocking and opening of the wing 14, the slider 80 moves in a straight direction into the respective groove of the wing 14. During the rotation of the arm 32 about the pin 118, the arm is guided and held in a stable position by the pins 124, 126, which are engaged in the respective circular portions 120b, 122b of the respective grooves 120, 122.

The guide system of the arm 32 formed by the first, second and third pin-slot couplings 110, 112, 114 allows a smooth transition and without jamming from the translational movement to the rotational movement, and vice versa, thanks to the fact that the pins 118, 124, 126 are movable within the respective slots 116, 120, 122 without the possibility of jamming during the transition from the straight portions 120a, 122a to the curved portions 120b, 122b.

Of course, without prejudice to the principle of the invention, the details of construction and the embodiments can be widely varied with respect to those described and illustrated, without thereby departing from the scope of the invention as defined by the claims that follow.

1. A device for opening and closing an outwardly opening pivoting wing, comprising:
an actuating device including a base and a toothed member rotatable with respect to the support and driven into rotation by a control device; and
an arm having a toothed portion including a circular toothed portion and a straight toothed portion, wherein the toothed member cooperates with the circular toothed section to swing the arm between a closed wing angular position and an open wing angular position, and vice versa, and wherein, in the closed wing angular position, the toothed member cooperates with the straight toothed portion of the arm for moving the arm along a straight direction between a locked wing position and an unlocked wing position, and vice versa, characterized in that the support and the arm cooperate with each other by means of a guide system comprising a first, a second and a third pin-slot coupling, wherein the first pin-slot coupling comprises a first straight slot that guides a respective first pin along a straight path, wherein the second and the third pin-slot coupling comprise a second slot and a third slot, respectively, which guide a second pin and a third pin, respectively, wherein both said second slot and third slot comprise a straight portion and a circumference arc portion with the center on the axis of said first pin.

2. A device according to claim 1, characterized in that said first slot is movable with respect to said first pin along a path with a length equal to the stroke of the arm between said closed and locked wing position, and said closed and unlocked wing position.

3. A device according to claim 1, characterized in that said second pin and said third pin are arranged on opposite sides with respect to a plane perpendicular to the longitudinal axis of the first slot and passing through the axis of the first pin.

4. A device according to claim 1, characterized in that each of said slots has two opposite guide walls spaced apart by a distance equal to the diameter of the respective pin.

5. A device according to claim 1, characterized in that said control mechanism comprises a worm screw fixed to said crank and meshing with a gear.
